(19) United States
(12) Patent Application Publication
(10) Pub. No.: US 2010/0049683 A1
(43) Pub. Date: Feb. 25, 2010

(54) COLLABORATIVE DEBATING TECHNIQUES

(76) Inventor: Stephen R. Carter, Spanish Fork, UT (US)

Correspondence Address: SCHWEGMAN, LUNDBERG & WOESSNER/NOVELL, PO BOX 2938, MINNEAPOLIS, MN, 55402, US

(21) Appl. No.: 12/196,857

(22) Filed: Aug. 22, 2008

(51) Int. Cl. G06N 5/00

(52) U.S. Cl. 706/46

(57) ABSTRACT

Techniques for collaborative debating are provided. Pieces of content are associated with particular identities and submitted to virtual communities. The content and the identities then receive metrics as: comments, attributions, and/or reputation ratings from various members of the virtual communities. The metrics are collected in a repository and subsequently summarized for requesters to assist in analyzing the credibility of the identities and/or the value that particular pieces content add to a particular debate within a particular virtual community.

### BACKGROUND

With the advent of high-bandwidth networking and the maturation of digital identity infrastructures, it is becoming increasingly desirable and possible to conduct substantive debates for governments, enterprises, and one's personal affairs over the Internet.

In fact, techniques associated with debating have largely not been automated to date. For the most part, debates are still conducted at large meetings or conferences. Furthermore, the reputations of debaters are subjective in nature and often preserved within the memories of the listeners and participants. This means that one new to a debate is starting from scratch when trying to judge the credibility and reliability of a particular debater's comments. Often a new participant relies on someone else's opinion of a debater to form the new participant's view of that debater. Yet, this is not always reliable because the person offering an opinion of another debater may him/her self have a suspect community reputation.

Another hindrance to conventional debating is that the true identity of a debater is usually known or easily discoverable by others. Therefore, if an individual had one suspect encounter or misstep in his/her past with a community, then that individual may be forever barred from getting acceptance from the community based on this one misstep and the community's perceived reputation of that individual. This occurs even when the individual has some valid points and information that could add to the value of the debate. On a related point, a potential debater may fail to participate in a debate solely because the potential debater lacks credentials that the community views as being a prerequisite to participating in the debate.

Still another issue associated with knowing the debater's identity in a debate is that some individuals may not be forthcoming or participate if they believe that they will be subject to the scrutiny of their peers. Such individuals may have a lot to offer to a particular debate and a particular community, but their fear of criticism prevents them from actively participating.

Thus, the debates are not as rich as they can or should be.

Accordingly, improved techniques for debating are desirable.

### SUMMARY

In various embodiments, techniques for collaborative debating are presented. More specifically, and in an embodiment, a method for collaborative debating is provided. A principal-selected identity is associated with a piece of content that is authored by or adopted by a principal. The piece of content and its association with the principal-selected identity is then committed to a collaborative virtual community. Finally, comments are gathered, within the collaborative virtual community, for the piece of content and ratings associated with a reputation of the principal-selected identity for subsequent analysis and reporting to the principal and other members of the collaborative virtual community.

### BRIEF DESCRIPTION OF THE DRAWINGS

FIG. 1 is a diagram of a method for collaborative debating, according to an example embodiment.

FIG. 2 is a diagram of a method for harvesting debate metrics, according to an example embodiment.

FIG. 3 is a diagram of a collaborative debating system, according to an example embodiment.

FIG. 4 is a diagram of another collaborative debating system, according to an example embodiment.

### DETAILED DESCRIPTION

A “resource” includes a service, system, device, directory, data store, user, groups of users, combinations of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

An “identity” is something that is formulated from one or more identifiers, secrets, and/or attributes that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc. As more and more identifiers are accumulated, a confidence in a particular identity grows stronger and stronger. In an embodiment, the identifier is a signature or a pair of signatures. For example, the signature of an identity service that vouches for a crafted identity, the signature of a principal associated with the crafted identity, or the signature of both the identity service and the principal.

“Authentication” is the process of validating the association of identifiers and secrets according to a policy, which is specific to the context in which the resulting identity is to be used. Thus, when identifiers are validated within a context specific to how an identity is to be used, it is authentication.

A “crafted identity” is an identity that may permit a principal's true identity to remain anonymous from the resource it seeks to access. With a crafted identity, an identity vault (e.g., one or more repositories holding secrets and identifiers) is opened to create the crafted identity and authenticate the principal to which it is associated, and then the identity vault is closed. Thereafter, the crafted identity can be validated by a resource, and acted upon without ever re-referencing the identity vault.

Example creation, maintenance, and use of crafted identities are discussed in U.S. patent Ser. No. 11/225,993 (“Crafted Identities”); commonly assigned to Novell, Inc. of Provo, Utah and the disclosure of which is incorporated by reference herein.

A “semantic identity” is a special type of identity that the agent can assume. Automated resources, such as services, may process the semantic identity over a network on behalf of the agent to which the semantic identity is associated. The semantic identity is confined or circumscribed to defined categories and interests identified by the agent. That is, the services that process the semantic identity over a network operate within a circumscribed semantic space of that network, where the semantic space is defined by the categories and the interests of the semantic identity.

Example creation, maintenance, and use of semantic identities are discussed in U.S. patent Ser. No. 11/261,972 (“Semantic Identities”), commonly assigned to Novell, Inc. of Provo, Utah and the disclosure of which is incorporated by reference herein.

An “attested identity” is a collection of attributes, roles, rights, privileges, and assertions; the validity of which is attested to by attesting resources according to stated policy. The activation of an attested identity involves the application of policy and testing of assertions, such that access to a resource is allowed, denied, partially allowed, or restricted in some manner.

Example creation, maintenance, and use of attested identities are discussed in U.S. patent Ser. No. 11/225,994 (“Attested Identities”), commonly assigned to Novell, Inc. of Provo, Utah and the disclosure of which is incorporated by reference herein.

In some embodiments, an identity service is used. Examples of an identity service can be found in: U.S. patent Ser. Nos. 10/765,523 (“Techniques for Dynamically Establishing and Managing Authentication and Trust Relationships”), 10/767,884 (“Techniques for Establishing and Managing a Distributed Credential Store”), and 10/770,677 (“Techniques for Dynamically Establishing and Managing Trust Relationships”). These applications are also commonly assigned to Novell, Inc. of Provo, Utah and the disclosures of which are incorporated by reference herein.

Various embodiments of this invention can be implemented in existing network architectures. For example, in some embodiments, the techniques presented herein are implemented in whole or in part in the Novell® network, identity management, directory services, and proxy server products, distributed by Novell®, Inc., of Provo, Utah.

Of course, the embodiments of the invention can be implemented in a variety of architectural platforms, operating and server systems, or applications. Any particular architectural layout or implementation presented herein is provided for purposes of illustration and comprehension only and is not intended to limit aspects of the invention.

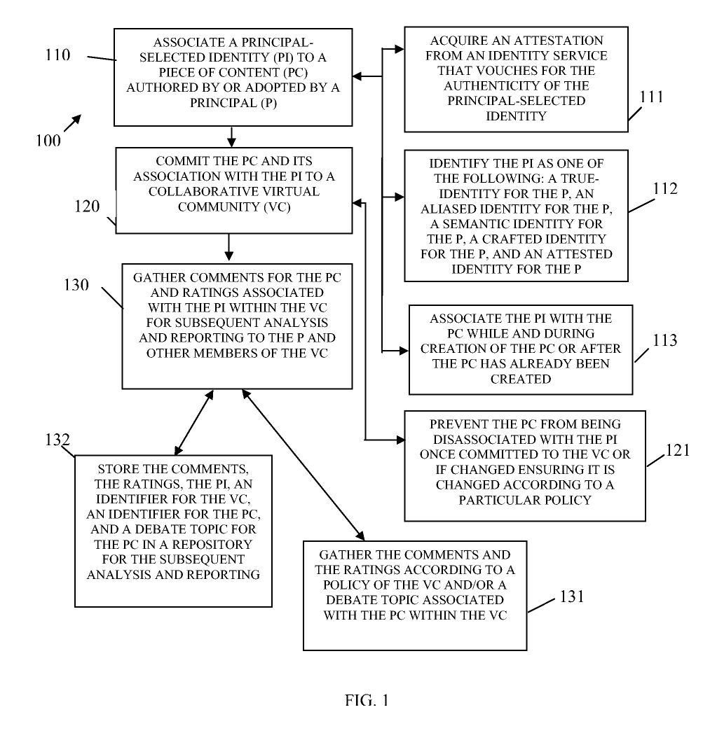

It is within this context that embodiments of the invention are now discussed with reference to the FIGS. 1-4.

FIG. 1 is a diagram of a method 100 for collaborative debating, according to an example embodiment. The method 100 (hereinafter “collaborative debating service”) is implemented in a machine-accessible and readable medium. The collaborative debating service is also operational over a network and the network can be wired, wireless, or a combination of wired and wireless.

Initially, a principal, such as a user (can also be an automated service acting on behalf of a user) creates an identity. This is done so that principal defined identity can be trusted by other entities that participate in collaborative debating virtual communities.

So, at 110, the collaborative debating service associates a principal-selected or defined identity to a piece of content authored by or adopted by the principal. The piece of content can be audio data, video data, text data, image data, graphical data or various combinations of these things. The content itself can be directed to or the subject matter of a particular topic within a particular debate that occurs within a particular collaborative virtual community.

In an embodiment, at 111, the collaborative debating service acquires an attestation from an identity service that vouches for the authenticity of the principal-selected identity. The attestation can accompany the association between the principal-selected identity and the piece of content. This permits others within a particular collaborative virtual community to validate the principal-selected identity. Example identity services that can provide such an attestation were discussed above and incorporated by reference herein.

In other cases, at 112, the principal-selected identity can be identified as being one of the following: a true identity for the principal, an aliased identity for the principal, a semantic identity for the principal, a crafted identity for the principal, and an attested identity for the principal. Examples of semantic, crafted, and attested identities were provided above and incorporated by reference herein.

According to an embodiment, at 113, the collaborative debating service can associate the principal-selected identity with the piece of content during or while the piece of content is being authored by the principal. In another situation, the association between the principal-selected identity and the piece of content is done at some point after the piece of content has already been created. This latter case, permits a principal to adopt someone else's created work (piece of content) as their own. This situation is frequently done in the business and academia industries.

It is also noted that any particular piece of content can be associated with multiple different identities. FIG. 1 is presented for purposes of illustration only and it is to be understood that multiple authors can be associated with a single work (piece of content).

At 120, the collaborative debating service commits the piece of content and its association with the principal-selected identity to a collaborative virtual community. Here, the principal associated with the principal-selected identity submits the piece of content (also referred to herein synonymously with “work”) to the collaborative debating service, which then commits the work and the identity association to the collaborative virtual community. In another situation, the principal is unaware of the collaborative debating service, which may be implemented as a proxy, such that the collaborative debating service intercepts a communication by the principal attempting to submit the work directly to the collaborative virtual community. At any point in time before the principal submits the work to the collaborative virtual community, the principal may change the principal-selected identity association with the work or may add or delete other assigned identities to the work; however, once submitted the principal generally may not alter the identity associations with the work. Yet, in some situations with the proper secure interactions between the collaborative debating service and in accordance with a defined policy, the identity association can be altered. For example, a new principal may be added, an existing one deleted, etc. In some situations, such changes to the identity association may result in any anonymous status of a principal being compromised. So, if changes are made to the identity association after with work is committed, those changes are guided by a policy.

So again, at 121 and in some embodiments, the collaborative debating service actively prevents the piece of content from being disassociated with the principal-selected identity, once the work is committed to the collaborative virtual community.

The collaborative virtual community can be any service provided via a network, such as the Internet, that permits registered users to debate or engage in various topic discussions with one another. This can include free services as well as services that require paid subscriptions.

At 130 and after the piece of content is committed to the collaborative virtual community, the collaborative debating service gathers or harvests comments for the piece of content and ratings associated with a reputation of the principal-selected identity. These metrics are gathered from monitoring the collaborative virtual community or via a modified collaborative virtual community that actively interfaces with and communicates with the collaborative debating service. The identity of the commenter (member identity) is noted in the metrics as is that member's reputation rating. This is notable because the weight given to the comment may hinge upon the reputation of the commenter. So, the member identity of the commenter and that commenter's reputation rating are noted in the metrics.

The metrics are gathered by the collaborative debating service for purposes of subsequent analysis and reporting back to the principal and other members of the collaborative virtual community.

According to an embodiment, at 131, the collaborative debating service gathers the comments and the ratings in accordance with instructions defined in a policy. The policy can be associated with the collaborative virtual community and/or a particular debate topic that the piece of content is assigned to within the collaborative virtual community.

In yet another case, at 132, the collaborative debating service stores: the comments, the ratings (reputation ratings for the principal-selected identity as noted by the commenting member and reputation rating known in the collaborative virtual community for the commenting member), the principal-selected identity, an identifier for the piece of content, an identifier for the commenting member, and/or a debate topic for the piece of content within a repository.

In an embodiment, the repository is a relational database. This provides a mechanism for performing a variety of subsequent custom analysis and custom report generation, since custom applications can be implemented using the application programming interface (API) of the relational database. Standard interfaces of the relational database can be used as well to search, analyze, and report on the information captured in the relational database. Example summaries that can be generated and forecasting metrics with respect to the piece of content, the principal-selected identity, and/or the debate are discussed in greater detail below. The ratings can be established by services and systems associated with the principal and/or the collaborative virtual community.

In other embodiments, the repository is an object database, a XML database, a data warehouse, a collection of logically associated files, and/or various combinations of these things. The combinations can also include the relational database embodiment as well.

In some cases, the principal-selected identity can include a variety of credential information that can be used by the collaborative virtual community and its members to validate the principal-selected identity and its association to the piece of content.

For example, unique key pairs can be associated with the principal-selected identity, such that a digital signature of the principal-selected identity can be used to uniquely identify the principal-selected identity from other identities within the collaborative virtual community. So, a private key of the principal-selected identity can be used to digitally sign the piece of content, and the public key associated with the signature can be acquired via an identity service by the other members of the collaborative virtual community or a validation service that processes within the collaborative virtual community. The public key can also be acquired via a certificate or via a globally-accessible repository for purposes of validating the digital signature of the piece of content. Note that the identity can be anonymous but even though it is anonymous it can still be verified in the manners discussed herein.

In other cases, the principal-selected identity is an anonymous identity that is not capable of being validated by the members of the collaborative virtual community or a service of the collaborative virtual community. In such a case, the piece of content itself may be inspected to resolve the authenticity of the piece of content; albeit this is not a reliable approach.

The comments about the piece of content may be viewed as contributions or attributions made by members of the collaborative virtual community. This can include further explanations that expand the debate to which the piece of content is assigned within the collaborative virtual community or this can be detailed remarks regarding the credibility of the principal-selected identity within the collaborative virtual community. Moreover, the comments or contributions can be added to the debate as directed by debate type organization policy that is specified by a particular debate site or the collaborative virtual community as a whole.

According to an embodiment, pieces of content (may also be referred to herein as “documents”) are collected and housed in attribution lists that the collaborative debating service maintains. In one case, this is via a relational database as discussed above. In another case, this is done via Extensible Markup Language (XML) formatted documents using the XML tags ID and IDREF relationships. In still another case, the document is scanned and the attribution lists built each time attributions are to be investigated. Attributions are accumulated for any selected identity, such as the principal-selected identity. So, all content received via a verifiable identity is associated with that verifiable identity.

The attributions can be accumulated via collaborative virtual communities and/or the identities. In some cases, the attributions are restricted to content provided by a particular identity during the time frame when the particular identity is registered with a particular collaborative virtual community.

It is also noted that, the member that supplies the comment (contribution or attribution) can actually be the principal using a different principal-selected or defined identity within the collaborative virtual community. So, the principal can effectively be carrying on a debate with himself or making remarks about his work within the collaborative virtual community and it appears to others within the collaborative virtual community that the commenting member is someone other than the principal-selected identity that submitted the work. The principal can take on different personas within the collaborative virtual community, each persona independently verified via a particular identity within the community and each having its own reputation and set of attributions.

Furthermore, each identity of the principal may have previously registered or joined the collaborative virtual community or even other different virtual communities in accordance with those communities' policies. Each community has its own charter or stated reason for existence within the network (such as the Internet).

Still further and in other embodiments, each identity is associated with a profile. Here, the identity indicates a type of membership that the identity has in a particular virtual community (also referred to as “debate community” herein). The principal then specifies in the profile for the identity being used by the principal how that identity is to be managed by the debate community services (e.g., what email address to use for the identity, what alias to use for the identity, etc.). In some cases, the principal can also specify what areas of interest (either positive or negative) that the identity is interested in. This can be done via semantic identity and semantic processing (discussed above and incorporated by reference herein).

The reputation ratings provide for a mechanism of judging a reputation for a particular identity within a particular virtual community or across different virtual communities. Each identity can be set as a row within a relational database and the virtual communities as columns within that database and the reputation rating identified at the intersecting field of the database for a particular identity and a particular virtual community. In another situation, the debates or the virtual communities are the rows and the identities are the columns again the intersection can include the reputation rating. The reputation rating can include, by way of example, a numeric value along a predefined scale, with one end of the scale being viewed as more favorable than the other end of the scale. Members can select a rating for the identity for each piece of content. The ratings can then be recorded by debate topic and/or by virtual community and averaged to supply the intersecting field values within the database. It is understood that other techniques can be used to quantify a reputation rating for a particular identity based on a particular piece of content for a particular debate topic and/or based upon the sum of all interactions the particular identity has had with a particular virtual community and/or all virtual communities.

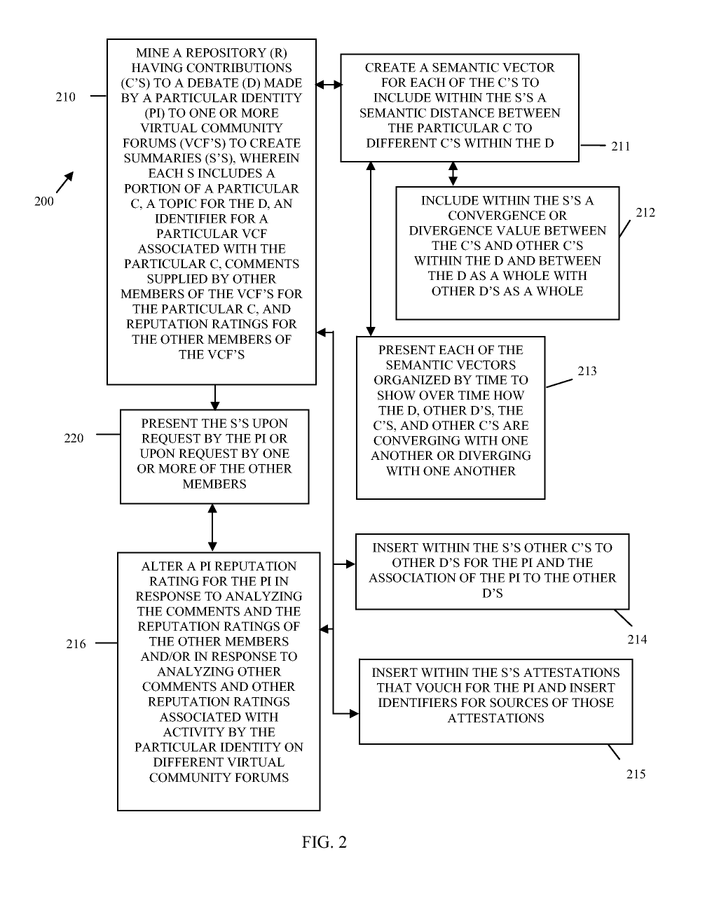

Once the comment, contribution, attribution and/or reputation rating about the principal-selected identity is acquired from a member of the collaborative virtual community a variety of analysis and reporting techniques can be achieved. Some of this processing is discussed below with reference to the FIG. 2.

FIG. 2 is a diagram of a method 200 for harvesting debate metrics, according to an example embodiment. The method 200 (hereinafter “debate harvesting service”) is implemented in a machine-accessible and readable medium. The debate harvesting service is operational over a network. The network may be wired, wireless, or a combination of wired and wireless.

The debate harvesting service represents processing that occurs after the debating service (represented by the method 100 of the FIG. 1) has processed a principal-selected identity and its association with a piece of content and after it has also gathered comments (contributions or attributions) and reputation ratings for that identity and that piece of content.

At 210, the debate harvesting service mines a repository. The repository includes contributions to a debate made by a particular identity within one or more virtual community forums. The debate harvesting service mines the repository to create summaries.

Each summary includes: a portion of a particular contribution made by the particular identity, a topic for the debate, an identifier for a particular virtual community forum that is associated with the particular contribution, comments supplied by other members of the virtual community forums for the particular contribution, and reputation ratings for the other members of the virtual community forums.

Within the context of the FIG. 2 the term “contribution” is to be distinguished from the term “comment” in that the contribution refers to the authored piece of content made by a particular identity to a particular debate topic. It is noted that in some contexts, such as what was described above with reference to the FIG. 1 that a contribution may also be viewed as a comment. The context of what is being submitted and by whom it is being submitted within the virtual community dictates whether a contribution is to be viewed as a comment about a particular work or identity or to be viewed as a piece of authored content submitted by the particular identity. Again, within the context of the FIG. 2 the term “contribution” may be used synonymously with the phrase “piece of content,” which was discussed at length above with reference to the FIG. 1.

According to an embodiment, at 211, the debate harvesting service can create a semantic vector for each of the contributions. The semantic vector is included within or associated with (via metadata) each summary. The semantic vector provides a quantifiable semantic distance between the contributions and other contributions within the debate, and between the debate as a whole with other debates as a whole. In other words, the semantic vector scores each contribution and/or debate and then uses the differences between the scores to illustrate similarities and differences between contributions and/or debates. Again, techniques for achieving semantic processing of this nature were discussed above and incorporated by reference herein.

Continuing with the embodiment at 211, and at 212, the debate harvesting service can also include within the summaries a convergence or divergence value between the contributions relative to other contributions within the debate, and between the debate as a whole to other debates as a whole. This can illustrate when debate topics are converging with one another or diverging from one another. This can be used to combine multiple debates into one within the virtual community or separate out a single debate into multiple independent debates within the virtual community.

In also continuing with the embodiment at 211, and at 213, the debate harvesting service can present each of he semantic vectors organized by time. This can be done within the summaries to illustrate and quantify temporally how the debate, other debates, the contributions, and other contributions are converging or diverging from one another over a time line. It also illustrates the history and progression of specific debates relative to one another.

In an embodiment, at 214, the debate harvesting service inserts within the summaries other contributions associated with other debates that are associated with the particular identity. The debate harvesting service can also include the association and membership that the particular identity has to these other debates.

In yet another situation, at 215, the debate harvesting service inserts within the summaries attestations that vouch for the particular identity. Moreover, the debate harvesting service can also include the sources of those attestations. So as an example, if identity service (X) provides an attestation (B) about the authenticity of identity (Y), an identifier for X and B appear in the summary for that Y.

According to an embodiment, at 216, the debate harvesting service alters a particular identity reputation rating for the particular identity in response to analyzing the comments and the reputation ratings of the other members and/or in response to analyzing other comments and other reputation ratings associated with activity by the particular identity on different virtual community forums. In this manner, the metrics gathered from the comments and activity of the particular identity within various virtual community forums can be used to provide an automatic revision to a reputation rating associated with that particular identity being used by a particular principal.

For example, suppose a commenting member supplying a comment provides negative remarks about the contribution of the particular identity and suppose further that the commenting member has a very high and respectable reputation rating (e.g., 10 out of a scale from 0-10 with 0 the lowest and 10 the highest) within the virtual community forum. In such a case, an analysis of the comment can reveal the negative words or phrases (e.g., “terrible,” “crap,” “needs work,” etc.) used or alternatively the comment itself may include a numeric or grade value that the commenting member scores (e.g., commenting member notes a score of 0 on a scale of 0 to 5 where 0 is the lowest and 5 is the highest).

Any of this information (negative words or negative score value) detected during analysis can lead to reducing a reputation rating associated with the particular identity. The actual reduction (in some cases increase) in the reputation rating can be governed by policy, such as weight a negative/positive comment based on the reputation of the commenter and score all comments by adding the weighted values and then adjust the reputation rating of the particular identity up or down by a predefined percentage (that can also be calculated by policy). In this manner, an analysis can be done on the comments from all the virtual community forums associated with the particular identity and the reputation rating of the particular identity automatically adjusted accordingly.

At 220, the debate harvesting service presents the summaries upon request by the particular identity or upon request by one or more of the other members that supplied the comments and/or reputation ratings for the contribution and the particular identity (as was discussed within the processing at 210). The presentation of the summaries can occur in a variety of configurable manners.

For example, the debate harvesting service can present the summaries as a dashboard view on a client of the principal identity or the other members. Thus, a window within a browser or a frame within a browser can provide a dashboard view of the summaries that are presented when the user associated with the principal identity or a user associated with one of the members selects an option to view the summaries for a particular identity, a particular contribution, and/or a particular debate. In this manner and in some embodiments, the debate harvesting service can be implemented as a plug-in to a World-Wide Web (WWW) browser that appears and can be activated to create and present summaries when a user participates in a virtual community via the browser and over the Internet.

The information included within the summaries (as discussed above) may be viewed as metrics that are mined from a repository and assembled for presentation about a given identity and/or about a given debate upon request.

In some embodiments, security and policy may also be implemented as an added processing layer to restrict access to some or all of the metrics based on the requesting identity, the particular virtual community, and/or the particular debate.

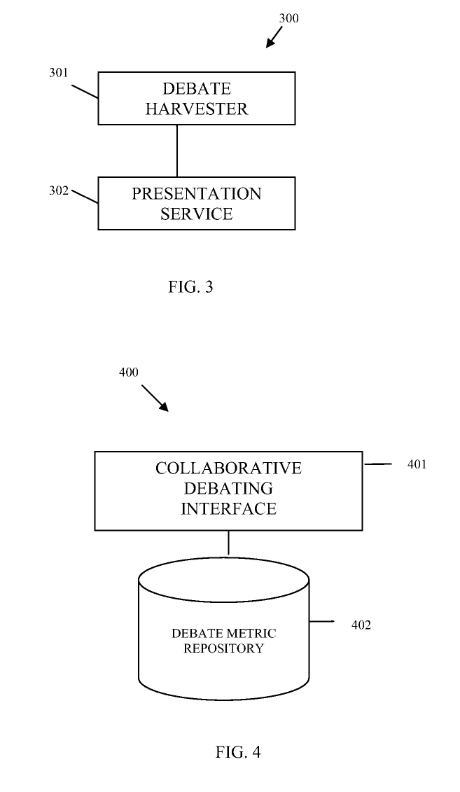

FIG. 3 is a diagram of a collaborative debating system 300, according to an example embodiment. The collaborative debating system 300 is implemented in a machine-accessible and computer-readable storage medium and is operational over a network. The network may be wired, wireless, or a combination of wired and wireless. In an embodiment, the collaborative debating system 300 implements among other things the debate harvesting service representing by the method 200 of the FIG. 2.

The collaborative debating system 300 includes a debate harvester 301 and a presentation service 302. Each of these will now be discussed in turn.

The debate harvester 301 is implemented in a machine-accessible and computer-readable storage medium as instructions that are processed on a machine (computer or processor-enabled device) over the network. Example processing associated with the debate harvester 301 was presented in detail above with reference to the method 200 of the FIG. 2. Furthermore, some aspects of the debate harvester 301 are presented above with reference to the method 100 of the FIG. 1.

The debate harvester 301 gathers metrics associated with a particular identity for debates occurring in one or more collaborative virtual communities. The debate harvester 301 then supplies those metrics to the presentation service 302 for subsequent presentation to a requesting user or principal (can be an automated service that scraps details from the metrics for purposes of other processing).

In an embodiment, the metrics include: identifiers for each of the debates, identifiers for contributions of content to each of the debates, identifiers for each of the collaborative virtual communities, comments made on each of the debates, and reputation ratings for the particular identity with respect to the debates.

In some cases, the debate harvester 301 acquires some of the metrics as semantic values that indicate a semantic distance between the contributions and/or the debates.

In still another case, the metrics include attestations made by third-parties that vouch for the authenticity of the particular identity.

The presentation service 302 is implemented in a machine-accessible and computer-readable storage medium as instructions that are processed on a machine (computer or processor-enabled device) over the network. Example processing associated with the presentation service was presented in detail above with reference to the method 200 of the FIG. 2.

The presentation service 302 provides summaries of the metrics in a presentation format to requesters. Policy and profiles can drive the exact rendered format of the summaries. Security may also block some metric information from appearing within the summaries. The blocked information can be x'd out indicating that something is missing to the requestor or can be missing entirely, such that the user is unaware that missing information was redacted out of the summaries.

In an embodiment, the presentation service 302 presents the summaries in a dashboard application on client devices of the requesters. For example, and as was discussed above, the dashboard application or the presentation service 302 itself can be implemented as a browser plugin on the client devices of the requestors to provide a dashboard view of the summaries on demand.

According to an embodiment, the requestors can include one or more of the following entities: members of one or more of the collaborative virtual communities, an administrator of a particular debate, and/or a user or principal associated with the particular identity.

FIG. 4 is a diagram of another collaborative debating system 400, according to an example embodiment. The collaborative debating system 400 is implemented in a machine-accessible and computer-readable storage medium and is to be processed by machines (computers or processor-enabled devices) over a network. The network may be wired, wireless, or a combination of wired and wireless. In an embodiment, the collaborative debating system 400 performs, among other things, the processing associated with the method 100 of the FIG. 1 and performs, among other things, the processing associated with the method 200 of the FIG. 2.

The collaborative debating system 400 includes a collaborative debating service 401 and a debate metric repository 402. Each of these will now be discussed in turn.

The collaborative debating service 401 is implemented in a machine-accessible and computer-readable storage medium as instructions that are processed on a machine (computer or processor-enabled device) over the network. Example processing associated with the debating service 401 was presented in detail above with reference to the methods 100 and 200 of the FIGS. 1 and 2, respectively and with reference to the system 300 of the FIG. 3.

The collaborative debating service 401 maintains an association between a particular identity with a piece of content and submits the association with the content to a collaborative virtual community. Once in the collaborative virtual community, the piece of content receives a comment from member of the collaborative virtual community.

The collaborative debating service 401 records the association, the piece of content (or an identifier therefor), a member identity for the member, and the comment within the debate metric repository 402. These metrics are subsequent retrieved from the debate metric repository 402 and presented in summary format to a requester in the manners discussed above with reference to the method 200 of the FIG. 2 and with reference to the system 300 of the FIG. 3.

According to an embodiment, the member identity is associated with a principal and the particular identity is also associated with the same principal. This indicates that the principal is pretending to be someone else that is different from the particular identity when the comment is supplied for the piece of content within the collaborative virtual community. Again, a principal can be using different identities to comment on his own work or to carry on a debate. This can be done for any number of reasons, such as the principal wants the debate topic to appear more appealing than it actually is, etc.

In another situation, the member is dynamically and actively invited to review the piece of content and supply the comment in response to an invitation sent according to one or more of the following: a policy whose evaluation triggers the invitation, a specific instruction received from the particular identity or an administrator, and/or a profile of the member whose evaluation indicates a match to a topic associated with the piece of content.

In an embodiment, the collaborative debating service 401 permits a principal assigned to the particular identity to estimate a potential impact or potential value that the piece of content is going to have on a particular debate within the collaborative virtual community before the principal commits the piece of content to that debate via the collaborative debating service 401. This can be done via the summary format and semantic vectors included therein as discussed above with reference to the method 200 of the FIG. 2 and with reference to the system 300 of the FIG. 3.

In some embodiments, the association (between the piece of content and the particular identity) is accompanied with a credential that permits the member and/or a service of the collaborative virtual community as a whole to validate the association between the piece of content and an authenticated particular identity.

The debating metric repository 402 is implemented in a machine-accessible and computer-readable storage medium and is accessible to the collaborative debating service 401 over the network.

The debating metric repository 402 houses the information identified above that is included in the summaries. The debating metric repository 402 can be a relational database, a data warehouse, a directory, a collection of logically associated files, and/or combinations of these things. In some cases, the entire or just a portion of the debate metric repository 402 can be dynamically constructed and housed in cache or volatile storage. In other cases, the entire or just a portion of the debate metric repository 402 resides in non-volatile storage.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
associating a principal-selected identity to a piece of content authored by or adopted by a principal;
committing the piece of content and its association with the principal-selected identity to a collaborative virtual community; and
gathering comments for the piece of content and ratings associated with the principal-selected identity within the collaborative virtual community for subsequent analysis and reporting to the principal and other members of the collaborative virtual community.

2. The method of claim 1, wherein associating further includes acquiring an attestation from an identity service that vouches for the authenticity of the principal-selected identity.

3. The method of claim 1, wherein associating further includes identifying the principal-selected identity as one of the following: a true-identity for the principal, an aliased identity for the principal, a semantic identity for the principal, a crafted identity for the principal, and an attested identity for the principal.

4. The method of claim 1, wherein associating further includes associating the principal-selected identity with the piece of content while and during creation of the piece of content or after the piece of content has already been created.

5. The method of claim 1, wherein committing further includes preventing the piece of content from being disassociated with the principal-selected identity once committed to the collaborative virtual community or if an identity association is changed ensuring the change conforms to a particular policy.

6. The method of claim 1, wherein gathering further includes gathering the comments and the ratings according to a policy of the collaborative virtual community and/or a debate topic associated with the piece of content within the collaborative virtual community.

7. The method of claim 1, wherein gathering further includes storing the comments, the ratings, the principal selected identity, an identifier for the collaborative virtual community, an identifier for the piece of content, and a debate topic for the piece of content in a repository for the subsequent analysis and reporting.

8. A machine-implemented method, comprising:
mining a repository having contributions to a debate made by a particular identity to one or more virtual community forums to create summaries, wherein each summary includes a portion of a particular contribution, a topic for the debate, an identifier for a particular virtual community forum associated with the particular contribution, comments supplied by other members of the virtual community forums for the particular contribution, and reputation ratings for the other members of the virtual community forums; and
presenting the summaries upon request by the particular identity or upon request by one or more of the other members.

9. The method of claim 8, wherein mining further includes creating a semantic vector for each of the contributions to include within the summaries a semantic distance between the particular contribution to different contributions within the debate.

10. The method of claim 9 further comprising, including within the summaries a convergence or divergence value between the contributions and other contributions within the debate and between the debate as a whole with other debates as a whole.

11. The method of claim 9 further comprising, presenting each of the semantic vectors organized by time to show over time how the debate, other debates, the contributions, and other contributions are converging with one another or diverging with one another.

12. The method of claim 8, wherein mining further includes inserting within the summaries other contributions to other debates for the particular identity and the association of the particular identity to the other debates.

13. The method of claim 8, wherein mining further includes inserting within the summaries attestations that vouch for the particular identity and identifiers for sources of those attestations.

14. The method of claim 8, wherein mining further includes altering a particular identity reputation rating for the particular identity in response to analyzing the comments and the reputation ratings of the other members and/or in response to analyzing other comments and other reputation ratings associated with activity by the particular identity on different virtual community forums.

15. A machine-implemented system, comprising:
a debate harvester implemented in a computer-readable storage medium and to process on a network; and
a presentation service implemented in a computer-readable storage medium and to process on the network;
wherein the debate harvester gathers metrics associated with a particular identity for debates occurring in one or more collaborative virtual communities and supplies those metrics to the presentation service, and wherein the presentation service provides summaries of the metrics in a presentation format to requesters.

16. The system of claim 15, wherein the metrics include identifiers for each of the debates, identifiers for contributions of content to each of the debates, identifiers for each of the collaborative virtual communities, comments made on each of the debates, and reputation ratings for the particular identity with respect to the debates.

17. The system of claim 16, wherein debate harvester acquires some of the metrics as semantic values indicating a semantic distance between the contributions and/or the debates.

18. The system of claim 15, wherein the metrics include attestations by third-parties that vouch for the authenticity of the particular identity.

19. The system of claim 15, wherein the presentation service presents the summaries in a dashboard application on client devices of the requesters.

20. The system of claim 15, wherein the requestors include one or more of the following: members of one or more of the collaborative virtual communities, an administrator of a particular debate, and a user associated with the particular identity.

21. A machine-implemented system comprising:
a collaborative debating service implemented in a computer-readable storage medium and to process on a network; and
a debate metric repository implemented in a computer-readable storage medium and to process on the network;
wherein the collaborative debating service maintains an association between a particular identity with a piece of content and submits the association with the content to a collaborative virtual community where the piece of content receives a comment from a member of the collaborative virtual community, and wherein the association, the piece of content, a member identity for the member, and the comment are recorded in the debate metric repository and subsequently retrieved there from and presented to a requestor in a summary format.

22. The system of claim 21, wherein the member identity is associated with a principal and the particular identity is also associated with the principal indicating that the principal is pretending to be someone else that is different from the particular identity when supplying the comment for the piece of content within the collaborative virtual community.

23. The system of claim 21, wherein the member is invited to review the piece of content and supply the comment in response to an invitation sent according to one or more of the following: a policy whose evaluation triggers the invitation, a specific instruction from the particular identity or an administrator, and a profile of the member whose evaluation indicates a match to a topic associated with the piece of content.

24. The system of claim 21, wherein the collaborative debating service permits a principal assigned to the particular identity to estimate a potential impact or potential value that the piece of content is going to have on a particular debate within the collaborative virtual community before the principal commits the piece of content to that debate via the collaborative debating service.

25. The system of claim 21, wherein the association is accompanied with a credential that permits the member and/or the collaborative virtual community as a whole to validate the association between the piece of content and the particular identity.
